(19) United States
(12) Patent Application Publication
(10) Pub. No.: US 2011/0125853 A1
(43) Pub. Date: May 26, 2011

(54) System and Method of Handling Electronic Mail Having Attachments

(76) Inventor: Anthony A. Weber, Bloomingdale, IL (US)

(21) Appl. No.: 12/626,453

(22) Filed: Nov. 25, 2009

(51) Int. Cl. G06F 15/16

(52) U.S. Cl. 709/206

(57) ABSTRACT

The system and method for handling email messages having at least one attachment. The system checks each outgoing email for attachments that are larger than a predefined size, detaches each such attachment from the email message, and splits each such attachment into segments. The system sends each of the segments to the addressees in separate emails so that each sent email is of a size less than the predefined threshold size. The system also includes a function that screens incoming emails or an inbox for split mail messages with separated attachments. For each detected split mail message, the system reassembles the original email along with the attachments.

### FIELD OF THE INVENTION

This invention relates to system of handling emails having one or more attachments, where the email is sent over a computer network.

### BACKGROUND OF THE INVENTION

Electronic Mail or email has become a significant and efficient method of transmitting information from sender to recipient, whether by local area network (LAN), wide area network (WAN), or world-wide-web network (WWW). In addition to the email message text, the transmitted information can also consist of one or more attached files, such as pictures, text documents, and or video. Many of the programs that handle the distribution of these emails (the email servers) on a network restrict the size of these attachments. This means that the sender must either manually split the attachment into parts, or rely on a third-party server to temporarily store the attachment until retrieved by the recipient. Each of these alternatives requires extra effort on the part of the sender and recipient in order to retrieve each entire attachment.

The present inventor recognizes that it would advantageous to automatically split an email having an attachment with a size that is greater than a predefined size into multiple emails.

### SUMMARY OF THE INVENTION

The system comprises a system and method of handling email messages that have one or more attachments. The system checks each outgoing email for attachments that are larger than a predefined size, detaches each such attachment from the email message. The system splits each such attachment into segments. The system sends each of the segments to the addressees in separate emails so that each sent email is below the email server attachment size limitation. The system also includes function that screen incoming emails or an inbox for split mail messages with separated attachments. For each detected split mail message, the system reassembles the original email along with the attachments.

In one embodiment, when a user submits an email for sending in an email program, the system automatically reacts to the sent event and checks each attachment's size against an predefined or userdefined threshold (segment size). Each attachment whose size is greater than the threshold is detached from the subject email. The attachment is split into attachment sub files or segments each equal to or less that the threshold size. Each segment is then attached to individual emails for transmission. In one embodiment, another email is created with information specific to each detached attachment, and is also sent to the same addressees. Code information is included in one or more sent messages to uniquely identify the message and enable the split messages combined at a destination location address.

When email is received by the recipient's email program, the system automatically detects that a split mail message has been received with detached attachments, locates all of the attachment and segment emails for each attachment, stitches each attachment back together, reattaches each attachment to the split mail message, and removes the special information, restoring the email back to its original contents. The system then deletes all of the attachment and segment emails.

Numerous other advantages and features of the invention will become readily apparent from the following detailed description of the invention and the embodiments thereof, from the claims, and from the accompanying drawings.

### BRIEF DESCRIPTION OF THE DRAWINGS

FIG. 1 is a diagram of a communications environment, consisting of computers and internal programs connected to the internet, and their relationship to the system;

FIG. 2 is a flow diagram of a state machine;

FIG. 2A is a flow diagram of the elements of a sub-state machine for one of the states shown in FIG. 2;

FIG. 2B is a flow diagram of the elements of a flowchart for one of the operations in FIG. 2.

FIG. 3 is a flow diagram of a SentSplitMailHandlerThread;

FIG. 4 is a flow diagram of a sub-state machine of one of the states of the SentSplitMailHandlerThread from FIG. 3;

FIG. 5 is a flow diagram of a creatingAttachmentEmail sub-state machine from FIG. 4;

FIG. 6 is a flow diagram of a creatingSegmentEmails sub-state machine from FIG. 4;

FIG. 7 is a flow diagram of a CheckForSplitMailThread state machine;

FIG. 8 is a flow diagram of a detectSMMessage( ) state machine from FIG. 7;

FIG. 9 is a flow diagram of a locateAllAttachments( ) state machine from FIG. 7;

FIG. 10 is a flow diagram of a restoringAttachments state machine from FIG. 7;

FIG. 11 is a flow diagram of a deletingSMMessages from FIG. 7;

FIG. 12 is a diagram view of select components of one type of email message;

FIG. 13 is a diagram view of select components of one type of email message containing one or more attachments;

FIG. 14 is a diagram view of a SplitMailMessage email;

FIG. 15 is a diagram view of a SplitMailAttachment email for attachment 2 from FIG. 14; and

FIG. 16 is a diagram view of a SplitMailSegment email for the first segment of attachment 2 from FIG. 14.

### DETAILED DESCRIPTION

While this invention is susceptible of embodiment in many different forms, there are shown in the drawing and will be described herein in detail specific embodiments thereof with the understanding that the present disclosure is to be considered as an exemplification of the principles of the invention and is not intended to limit the invention to the specific embodiments illustrated.

### System Overview

The invention comprises a system 16 and method of handling email messages that have one or more attachments. In one embodiment, the system 16 is an add-in’ or ‘plug-in’. This is because the invention relies on its host program, an email program, to establish and control the connection one or more email service(s), and to provide the invention access to outgoing and incoming emails. The system works in conjunction with a host email client program, such as Microsoft Outlook, Lotus Notes, or Mozilla Thunderbird email client programs. The email program may establish and control the connection one or more email service(s), and provide the system access to outgoing and incoming emails. In another embodiment, the system includes the email program.

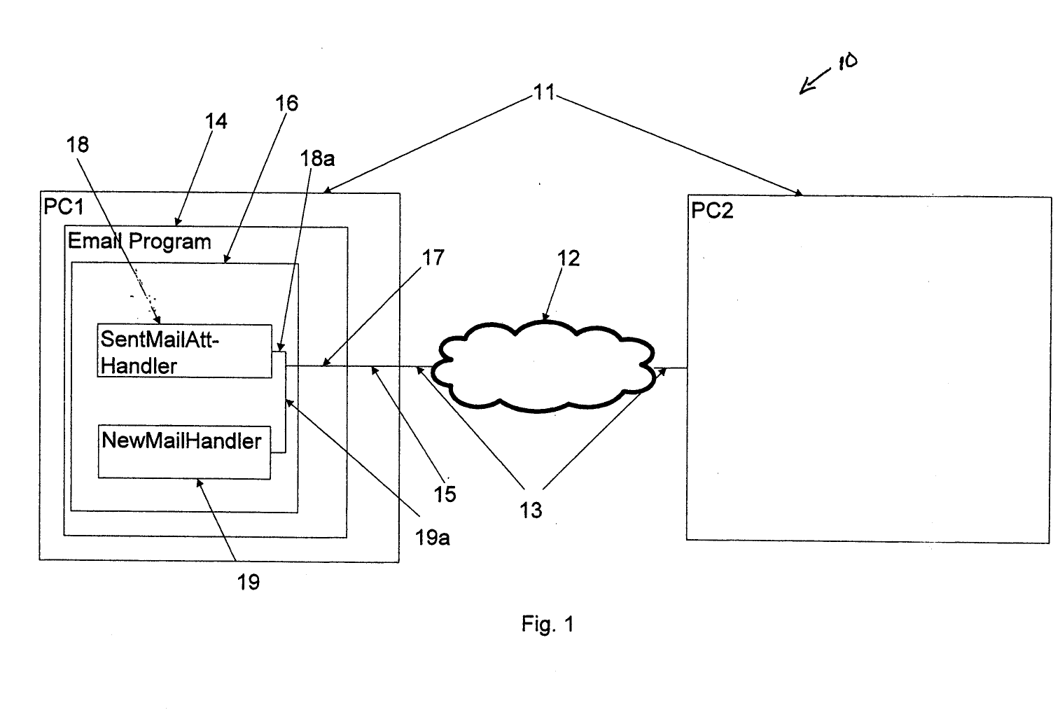

In one embodiment, the operating environment for the system is an email program into which the invention has attached, inserted, or loaded or is connectable with the email program. The email program can include a software application created to execute on a computer (PC) or over a computer network, such as the Internet. FIG. 1 is a diagram of an operating environment 10 of the system, showing two computers (PCs) 11, each of which are connected to a network 12, such as the Internet, by wired or wireless connections 13. An email program 14 is shown within one of the PCs, connected to the network 12 through the PC. The second computer PC 2 also contains the configuration as that shown in PC 1. Each of the computers contain an information carrier, such as a RAM, a harddrive, a flashdrive, flash memory. The information carrier is capable of containing instructions for carrying out the functions, operations, and/or states of the system 16. The instructions for carrying out the system 16 are executed by a processor, such as a CPU, of the computer 11.

The system 16 has a SentSplitMailHandlerThread, labeled SentMailAttHandler 18, and a CheckForSplitMailThread, labeled NewMailHandler 19, each shown connected 18a and 19a to the email program in FIG. 1.

A candidate email is an email that is to be sent by an email program having the system 16. A target email message is a candidate message with an attachment above a predetermined or user defined threshold size. A split mail message is a target message having coded original message information added to it and one or more specific attachments removed from it.

The SentSplitMailHandlerThread 18 of the system 16 checks for attachments to outgoing emails. If any attachments are greater in size (bytes) than the predetermined threshold size, then the candidate email is a target email and will be converted to a split mail message by the system. Each attachment larger than the threshold size is detached from the split mail message.

An attachment email is created for each detached attachment. The attached email contains coded attachment information. The system splits the attachment into segments or attachment sub files that are equal or less in size than the threshold size. The system creates a split segment email set that includes a number of split segment emails corresponding to the number of segments. The system attaches one segment to each split segment email.

The attachment email contains coded attachment information and the split segment emails contain coded split information. The coded original message information, coded attachment information, and coded split information contain information that that uniquely identify a split mail message, an attachment mail message, and a split mail message, respectively. This unique information enables the CheckForSplitMailThread to recreate the original message from the split mail message, the attachment mail message(s), and the split segment emails. The content of the coded information is explained below.

In one embodiment, coded information is placed into the email subject field. In other embodiments the coded split information may be placed in other areas of an email message, such as the header, the footer, or the body.

In one embodiment, the system may have a set coded information location function that lets a user define where the coded information will be stored. Correspondingly, if the user is able to set the location where the coded information is stored then the system may be configured to look in all possible locations for the coded information.

The CheckForSplitMailThread 19 of the system 16, routinely or as initiated by a user, checks the email program email inbox for incoming or newly received unprocessed emails. If any emails contain the coded information, the system then checks all of the emails or new emails in the inbox to find all of the split emails related to the coded information. For each entire email set located, the system locates and reunites or stitches each attachment together from the segments. The system appends each reunited attachment back to the split mail message. The original email's subject is restored. Then all of the separate attachment and segment emails are deleted.

The system provides a set predefined threshold function to allow the user to set the predefined threshold size. The system provides a set inbox function allowing the user to define an alternate inbox that the system will check for incoming split mail message sets.

### State Machine

In one embodiment the system utilizes a state machine that maybe carried out by or describe the operation of software the systems. The state machine describes how the system will respond to events. An event may be any stimulus that the state machine may receive, such as a user command, or a result from a function. Generally, the state machine is either waiting within a state for an event to be received, or transitioning from state to state in response to an event. The state machine may take action upon entry into a state, upon exit from a state, or in response to an event while in a state. The state machine responds to events by causing state machine to transition between states, or remain in the same state.

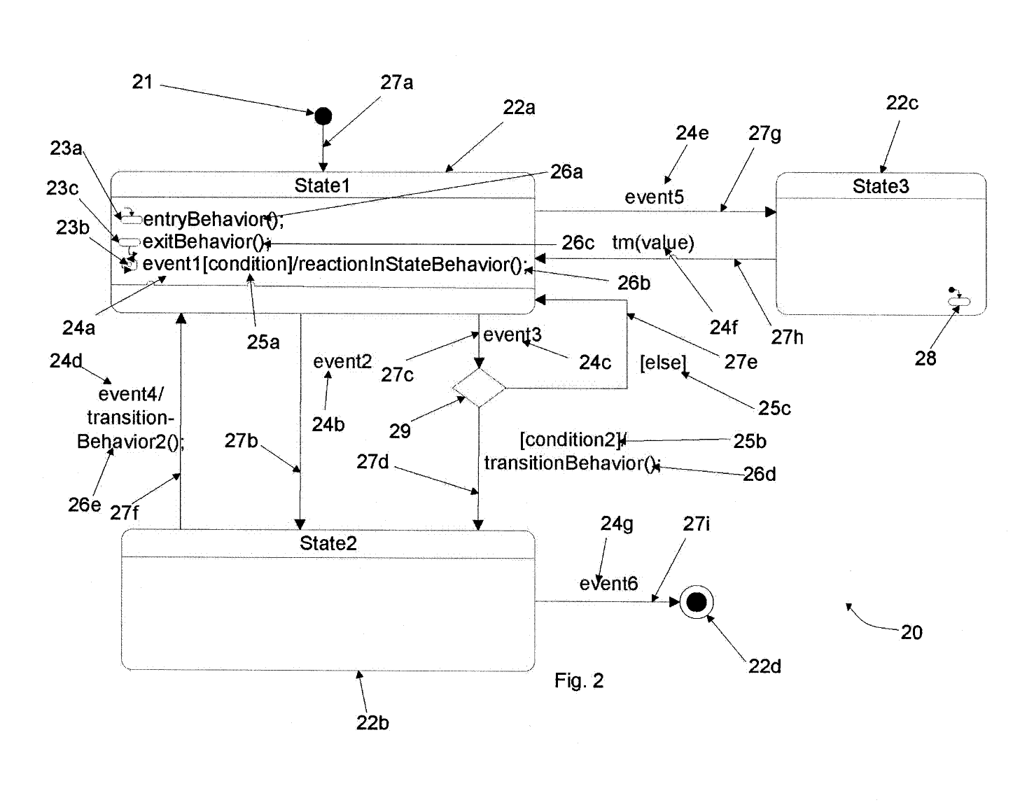

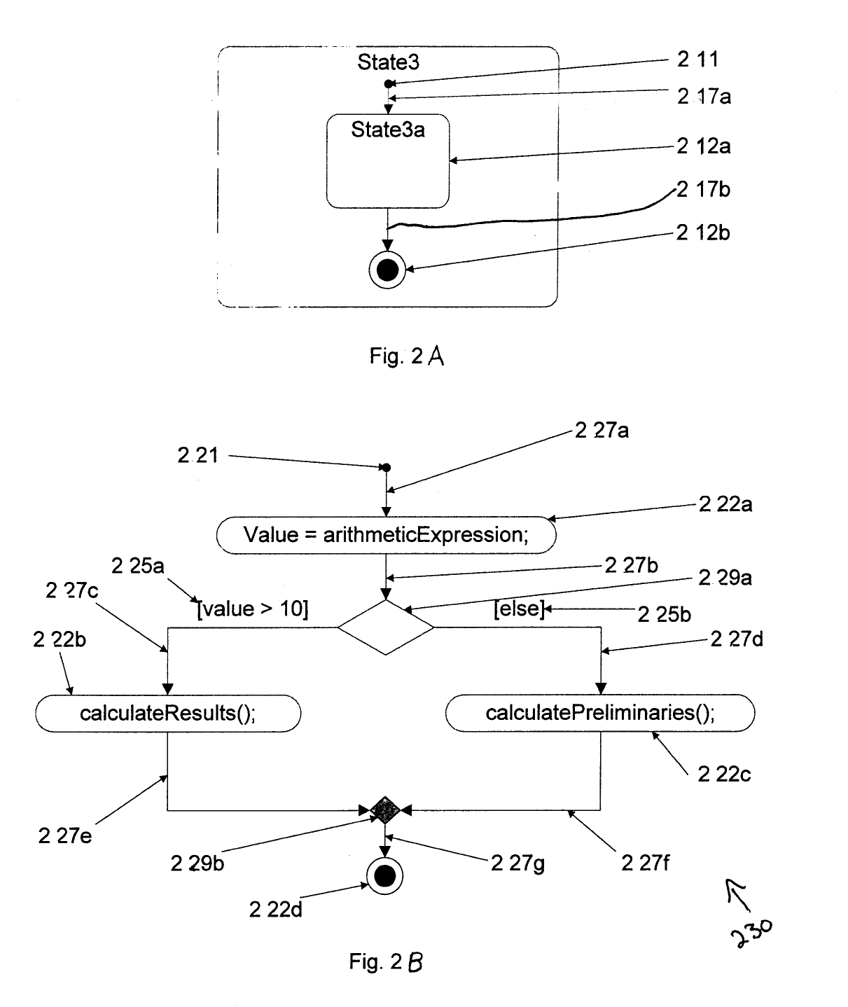

An exemplary state machine 20 is shown in FIG. 2. Although there are multiple styles available for describing state machines, the style being used here is described in detail in the Unified Modeling Language version 2, or UML2 by the Object Management Group. The state machine 20 has one pseudostate 21, and three states, 22a, 22b, and 22c. The state machine starts in the pseudostate 21, and transitions 27a to state 22a, wherein the action upon entry 23a behavior, ‘entryBehavior( )’ 26a is performed. While in State1 22a, the state machine can respond to events, event1 24a, event2 24b, event3 24c, or event5 24e. If event1 24a occurs, the function, ‘reactionInStateBehavior( )’ 26b, is performed, if a guard ‘condition’ 25a is true at the time event1 is received. Otherwise the event is ignored. If event2 24b occurs, the state machine transitions 27b out of State1 22a, causing the ‘action upon exit’ 23c function, ‘exitBehavior( )’ 26c, to be performed, taking the state machine to State2 22b.

If event 3 24c occurs, a decision 29 with two alternatives, ‘condition2’ 25b, and ‘else’ 25c, is evaluated by the state machine. If ‘condition2’ 25b is true, then the transition 27c-27d is taken, transitioning the state machine out of state State1 22a, causing the behavior, ‘exitBehavior( )’ 26c, to be performed, the transition behavior, ‘transitionBehavior( )’ 26d, to be performed, taking the state machine into to State2 22b. If ‘condition2’ 25b is false, then the condition, ‘else’ 25c is true and the transition 27c-27e is taken, transitioning the state machine out of state State1 22a, causing the behavior, ‘exitBehavior( ) 26c, to be performed, taking the state machine back into State1 22a, wherein the ‘entryBehavior( )’ 26a is performed. If event5 24e occurs, the state machine will transition 27g out of State1 22a, causing the ‘action upon exit’ 23c behavior, ‘exitBehavior( ) 26c, to be performed, taking the state machine to State3 22c.

While in State2 22b, the state machine can respond to two events, ‘event4’ 24d and ‘event6’ 24g. If event4 24d occurs, the transition 27f is taken, transitioning the state machine out of State2 22b, causing the behavior, ‘transitionBehavior2( )’ 26e, to be performed, taking the state machine back into State1 22a, wherein the behavior, ‘entryBehavior( ) 26a is performed. If event6 24g occurs, the transition 27i is taken, transitioning the state machine out of State2 22b to the termination state 22d, where the state machine terminates, or returns to the program (or state) that started the state machine.

While in state3 22c, the state machine can respond to one event, ‘tm(value)’ 24f, which is a timeout event, whose timeout value was started upon entry into State3 22c and incremented with time. Upon entry into state3 22c, the state machine will also enter into the sub-state machine 28, and react to events just as in states 22a, 22b, and 22c. The sub-state function of state3 is shown in FIG. 2A and explained below. When tm(value) 24f occurs, the transition, 27h is taken, transitioning the state machine out of the sub-state machine 28 (if still within) and out of State3 22c, taking the state machine back into State1 22a, wherein the behavior, ‘entryBehavior( )’ 26a is performed.

FIG. 2A shows the a sub-state machine of the state machine 20 within State3 22c. Upon entry at 211, the state machine transitions 217a into state state3a 212a, wherein the transition 217b is evaluated, and since there is no event, the transition 217b is taken, transitioning the state machine to the termination state 212b, wherein the sub-state machine returns control to State3 22a. What is described here as a state, may also be understood as a function or module of a program.

FIG. 2B shows a flowchart of one function, operation, or behavior of the state machine called transitionBehavior( ) 230. Upon entry 221, the operation transitions 227a to the activity 222a, wherein the statement or function, ‘value=arithmeticExpression’ is performed. Once the activity is completed, the operation transitions 227b to the decision block 229a, wherein the guard 225a on first transition 227c and the guard 225c on second transition 227d are evaluated. Only one of the guard conditions can be true. If the guard 225a, ‘value>10’, on transition 227c is true, then the activity 222b, and statement, ‘calculateResults( )’ is performed. Otherwise, the guard 225b, ‘else’ (the guard that becomes true when others are not) is true and the transition 227d is taken, and activity 222c, and statement ‘calculatePreliminaries( )’ performed. Once the activity 222b is completed, the operation transitions 227e to the merge 229b Once the activity 222c is completed, the operation transitions 227f to the merge 229b. Once at the merge 229b, the transition 227g is taken, transitioning the operation to the ActivityFinal 222d, returning control back to the caller of the operation.

### One Embodiment

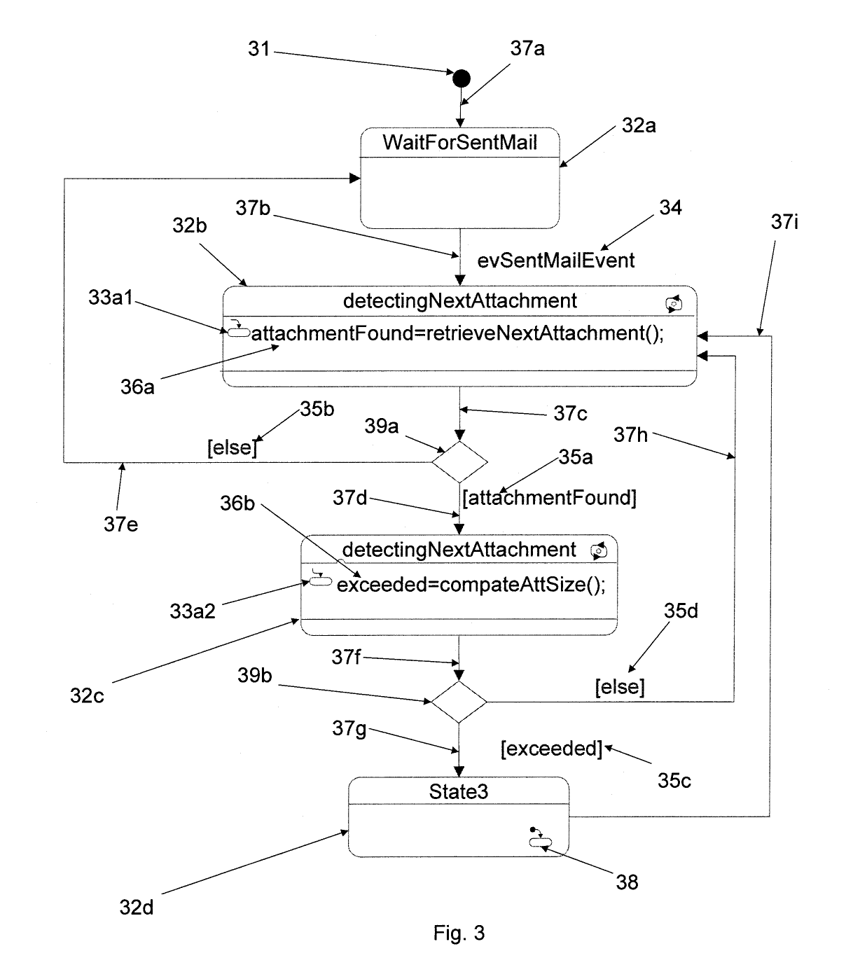

The system 16 state machine behavior of the SentSplitMailHandlerThread 18 is shown in FIG. 3. The SentSplitMailHandlerThread 18 receives an event from the email program 14 that an email is being sent. The thread 18 intercepts the email. The thread 18 scans the email for attachments that are larger than the predefined threshold size. If the email has an attachment larger than the predefined threshold size, the Thread 18 detaches each from the email, converts the email to a SplitMailMessage, creates SplitMailAttachment emails for each attachment, and splits each attachment into threshold-sized segments which are then each attached to SplitMailSegment emails. The thread 18 sends or releases the split mail emails to the email program 14 to the recipient address defined in the original email.

As shown in FIG. 3 the SentSplitMailHandlerThread 18, operating in state machine fashion, the state machine enters at enters 31, and begins a waits function at the default ‘waitingForSentMail’ state 32a. Upon receipt of an event, ‘evSentMailEvent’ 34 sent by the email program 14, a candidate email is received and the state machine transitions 37b to ‘detectingNextAttachment’ state 32b.

Upon entry into ‘detectingNextAttachment’ state 32b, the entry 33a1 behavior, ‘attachmentFound=retrieveNextAttachment( )’ 36a is performed. If an attachment is found, it is retrieved, and ‘attachmentFound’ is set to true. If an attachment is not found, ‘attachmentFound’ is set to false.

Once the entry action 36a completes, the decision 39a is evaluated. At decision 29a, if ‘attachmentFound’ 35a is true, the transition 37c-37d is taken, transitioning the state machine into the ‘checkingSize’ state 32c. Otherwise, ‘else’ 35b is true and the transition 37c-37e is taken, transitioning the state machine back to the ‘waitingForSentMail’ state 32a.

Upon entry into ‘checkingSize’ state 32c, the entry action 33a2, ‘exceeded=compareAttSize( )’ 36b is performed. If the retrieved attachment's size is greater than a predefined threshold size, then ‘exceeded’ is set to true. If the attachment's size is less than or equal to the threshold size, then ‘exceeded’ is set to false

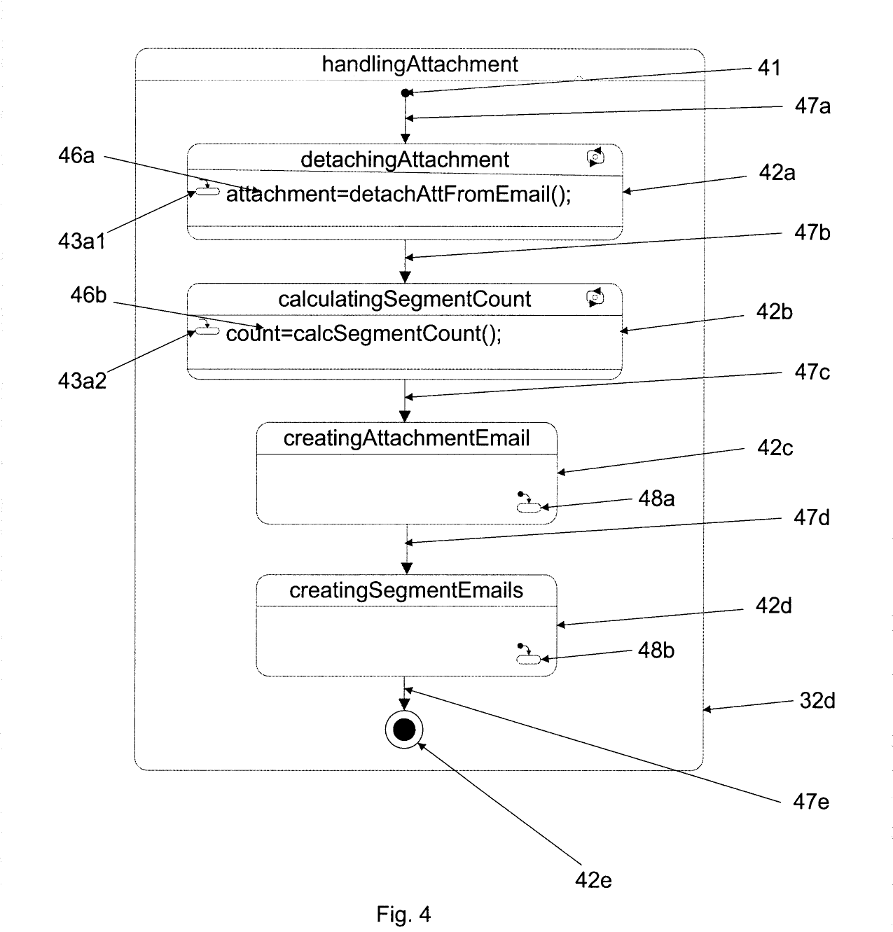

Once the entry action 36b completes, the decision 39b is evaluated. At decision 39b, if ‘exceeded’ is true, the transition 37f-37g is taken, transitioning the state machine into ‘handlingAttachment’ state 32d and into sub-state 38. The ‘handlingAttachment’ function/state is explained below and shown in FIG. 4. Otherwise, ‘else’ 35d is true and the transition 37f-37h is taken, transitioning the state machine back to state 32b in order to detect the next attachment of the email, if it exists.

FIG. 4 shows the sub-state machine behavior of the ‘handlingAttachment’ state 32d, which controls the behavior involved with detaching the large attachment, splitting it into segments, creating a SplitMailAttachment email with information about that attachment, creating SplitMailSegment emails, each with one segment as attachment, and sending them to the same addressee(s).

Upon entry into the sub-state machine at 41, transition 47a is taken, transitioning the sub-state machine into ‘detachingAttachment’ state 42a. Upon entry into ‘detachingAttachment’ state 42a, the entry action 43a1, ‘attachment=detachAttFromEmail( )’ 46a is performed and the attachment is removed from the candidate email and saved to a temporary or permeate location. Once the entry action 43a1 completes, the transition 47b is taken, transitioning the sub-state machine into ‘calculatingSegmentCount’ state 42b.

Upon entry into ‘calculatingSegmentCount’ state 42b, the entry action 43a2, ‘count=calcSegmentCount( )’ 46b is performed. There, the size of the attachment is divided by the threshold size to determine the number of attachments. If there is a remainder, the last segment of the attachment will contain that number of bytes. The number of threshold-sized segments is determined by the following equation:

$$SegmentCount = int ( \frac{AttachmentSize}{SegmentSize} ) \qquad Equation 1$$

Where int( ) is the integer value of the result of the division. In other words, the integer value of 5/2 would be 2, with the remainder discarded. If there is a remainder, another segment will be required, with its size determined by the following equation:

RemainderSize=AttachmentSize−AttachmentCount*SegmentSize Equation 2

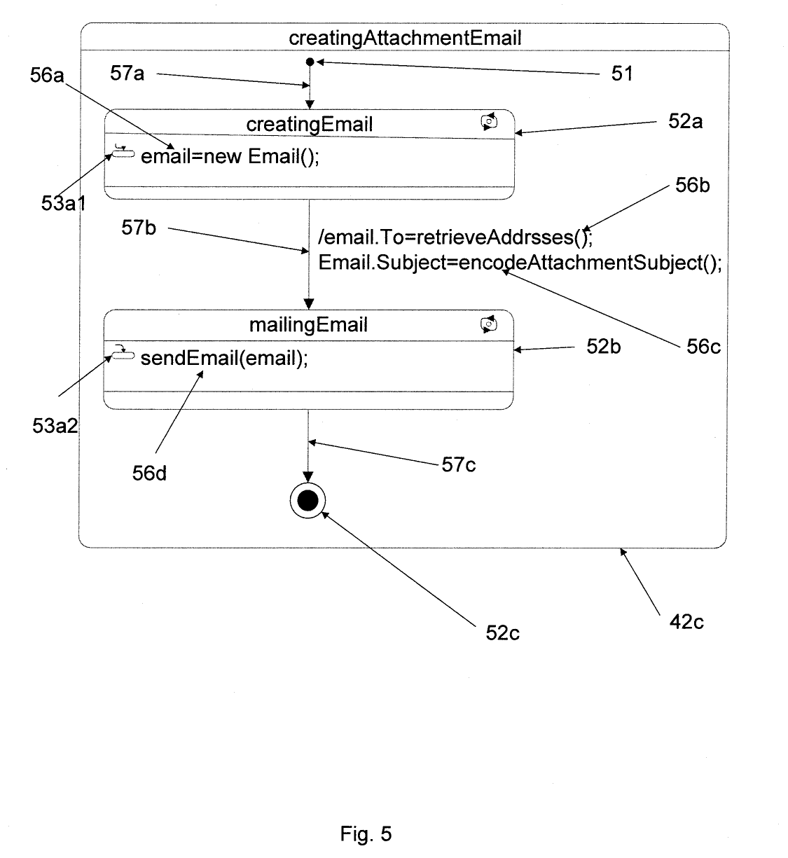

If the RemainderSize is greater than zero, the total number of attachments will be increased by 1 to accommodate the remainder's segment. Once the entry action 43a2 completes, the transition 47c is taken, transitioning the sub-state machine into ‘creatingAttachmentEmail’ state 42c and then into sub-state machine 48a. The ‘creatingAttachmentEmail’ state is described below and shown in FIG. 5.

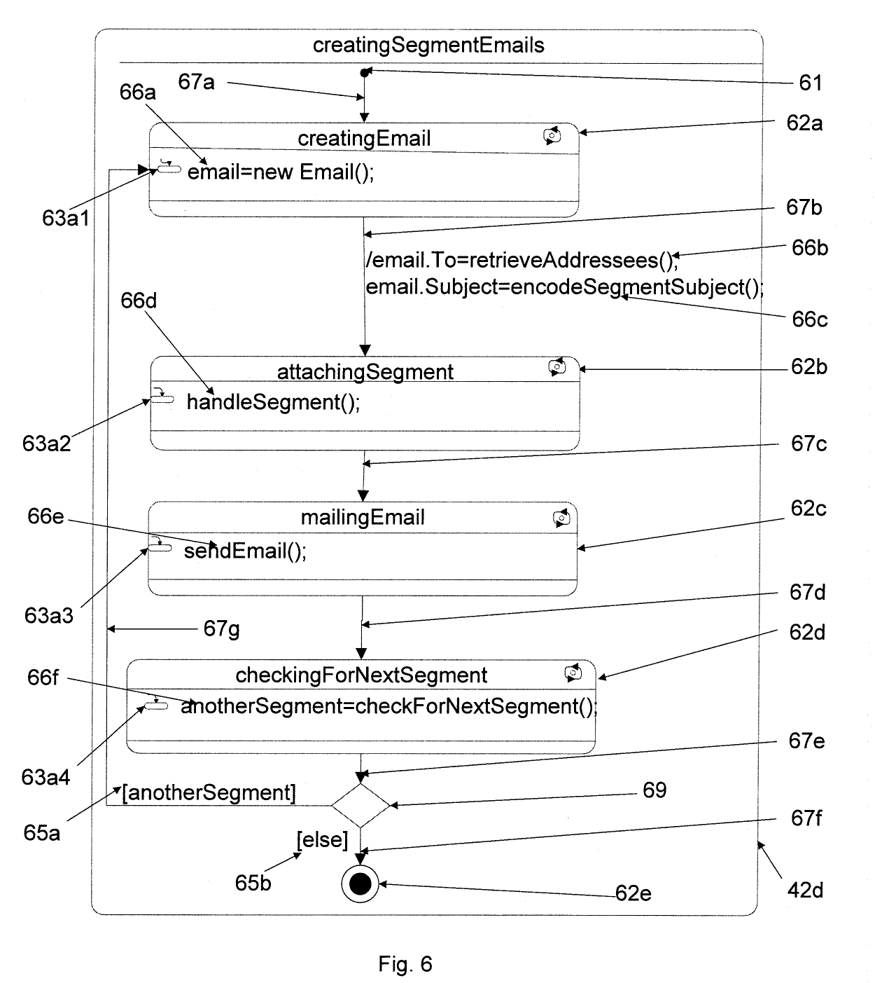

Once the sub-state behavior 48a is completed, the transition 47d is taken, transitioning the sub-state machine into ‘creatingSegmentEmails’ state 42d, and then into sub-state machine 48b. The ‘creatingSegmentEmails’ state is described below and shown in FIG. 6.

Once the sub-state behavior 48b is completed, the transition 47e is taken, transitioning the sub-state machine to the termination state 42e, returning the sub-state machine to ‘handlingAttachment’ state 32d.

FIG. 5 shows the sub-state machine behavior of the ‘creatingAttachmentEmail’ state 42c, which controls the creation, coding, and sending of the SplitMailAttachment email. Upon entry into the sub-state machine at 51, transition 57a is taken, transitioning the sub-state machine into ‘creatingEmail’ state 52a. Upon entry into ‘creatingEmail’ state 52a, the entry action 53a1, ‘email=new Email( )’ 56a is performed and a new email is created.

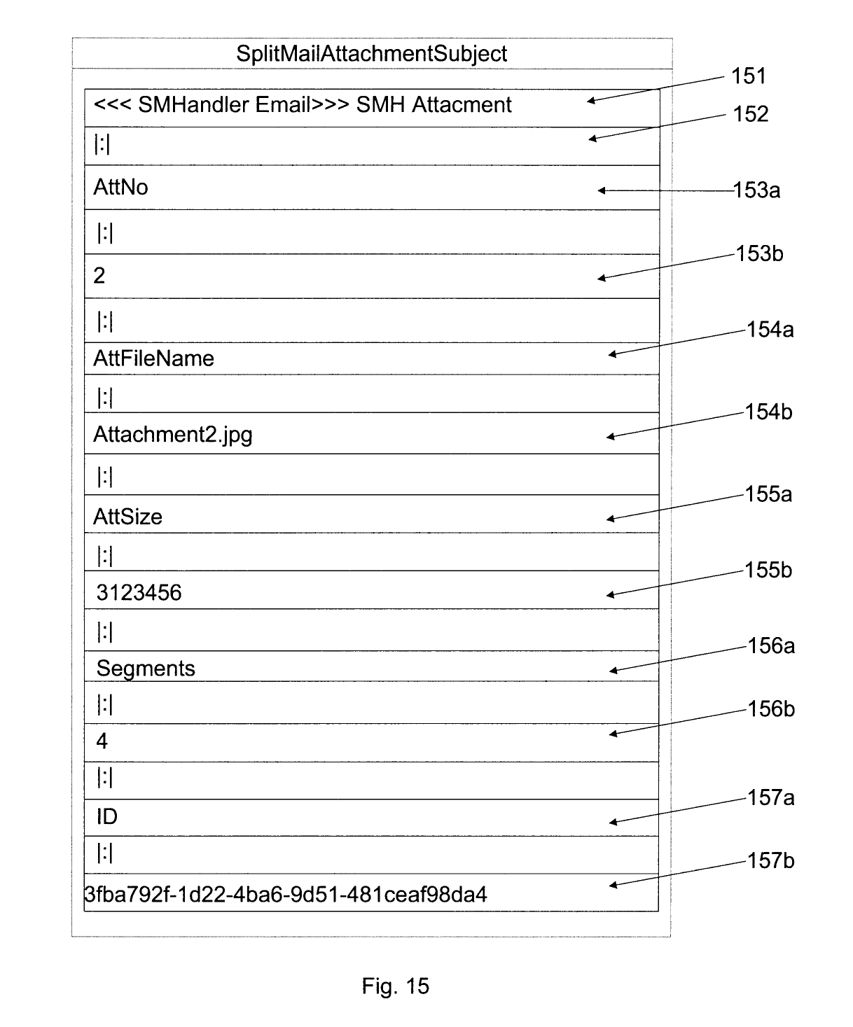

Once the entry action 53a1 completes, the transition 57b is taken. The transition behaviors, ‘email.To=retrieveAddressees( )’ 56b and ‘email.Subject=encodeAttachmentSubject( ) 56c are performed, transitioning the sub-state machine into ‘mailingEmai’ state 52b. The split mail attachment email's recipients are identical to that of the original candidate email. The split mail attachment email's subject is encoded with coded attachment information according an EncodeSubject SplitMailAttachment function as described below and shown in FIG. 15.

Upon entry into ‘mailingEmail’ state 52b, the entry action 53a2, ‘sendEmail( )’ 56d is performed and the attachment email is sent to the addressees. In embodiment, the system may hold attachment emails until all attachment emails are created and then sent at one time in a batch fashion. Once the entry action 53a2 completes, the transition 57c is evaluated and is taken, transitioning the sub-state machine to the termination state 52c, returning control to the ‘creatingAttachmentEmail’ state 42c.

FIG. 6 shows the sub-state machine behavior of the ‘creatingSegmentEmails’ state 42d, which controls the creation of the SplitMailSegment emails, attaching each segment, and then sending them to the addressees. Upon entry into the sub-state machine at 61, transition 67a is taken, transitioning the sub-state machine into creatingEmail' state 62a. Upon entry into ‘creatingEmail’ state 62a, the entry action 63a1, ‘email=new Email( )’ 66a is performed and a new email is created.

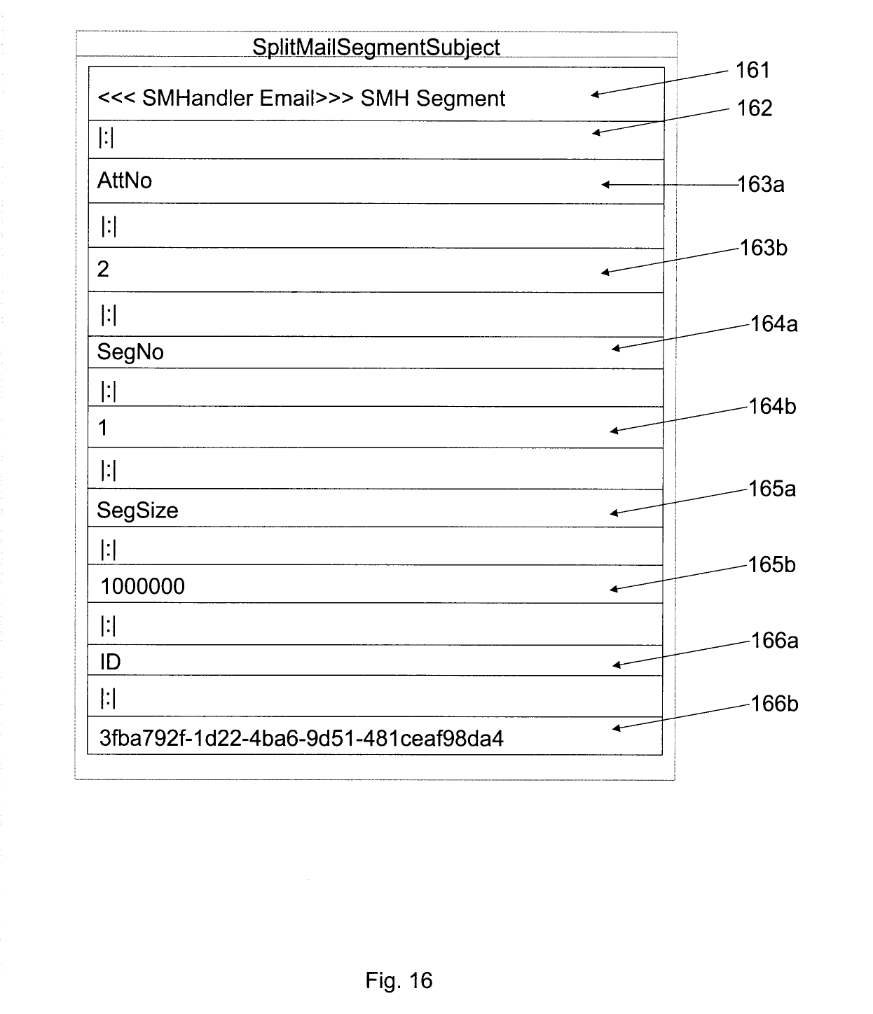

Once the entry action 63a1 completes, the transition 67b is taken. The transition behaviors, ‘email.To=retrieveAddressees( )’ 66b and ‘email.Subject=encodeSegmentSubject( ) 66c are performed, transitioning the sub-state machine into ‘attachingSegment’ state 62b. In one embodiment, during the transition, the split mail segment email's recipients are identical to that of the candidate email. The split mail segment email's subject is encoded with coded split information according an EncodeSubjectSplitMailSegment function as described below and shown in FIG. 16.

Upon entry into ‘attachingSegment’ state 62b, the entry action 63a2, ‘handleSegment( )’ 66d is performed and the attachment's next segment is retrieved, a header character string, such as “Split Mail Handler” pre-pended to it. Then the segment is then attached to the segment email. Once the entry action 63a2 completes, the transition 67c is taken, transitioning the sub-state machine to the ‘mailingEmail’ state 62c. Upon entry into ‘mailingEmail’ state 62b, the entry action 63a3, ‘sendEmail( )’ 66e is performed and the segment email is sent to the addressees. In embodiment, the system may hold segment emails until all segment emails are created and then sent at one time in a batch fashion.

Transition 67d is taken, and entry action 66f of checkingForNextSegment 62d is evaluated. If ‘anotherSegment’ is true, the transition 67e-67f is taken, transitioning the sub-state machine back to ‘creatingEmail’ state 62a. If ‘anotherSegment’ is false, the transition 67e-67g is taken, transitioning the sub-state machine to the termination state 62e, returning control to the ‘creatingSegmentEmails’ state 42d.

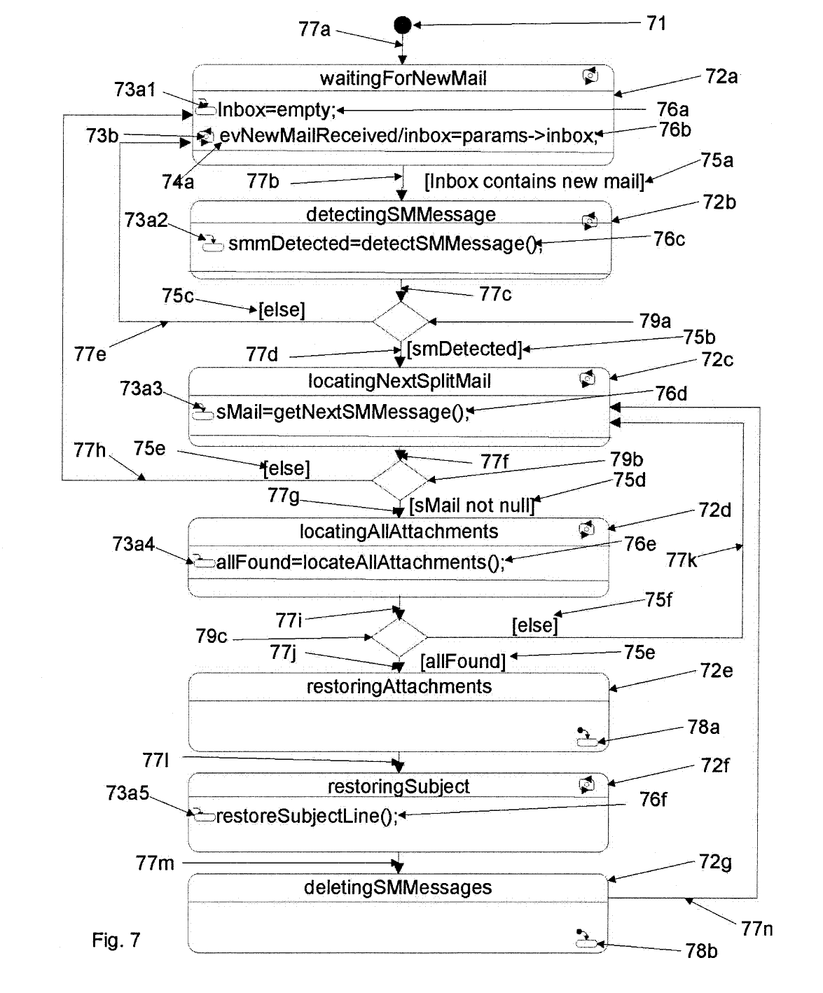

FIG. 7 is a diagram showing the state machine behavior of the CheckForSplitMailThread 42, which scans the presented inbox for SplitMailMessage, SplitMailAttachment, and SplitMailSegment emails. If any are found, then for each SplitMailMessage, if all attachment and segment emails are located, each attachment's segments are stitched back together and reattached to the SplitMailMessage. The SplitMailMessage is then converted back to the original message. The request to scan an inbox is received either from the email program 14, or from the user.

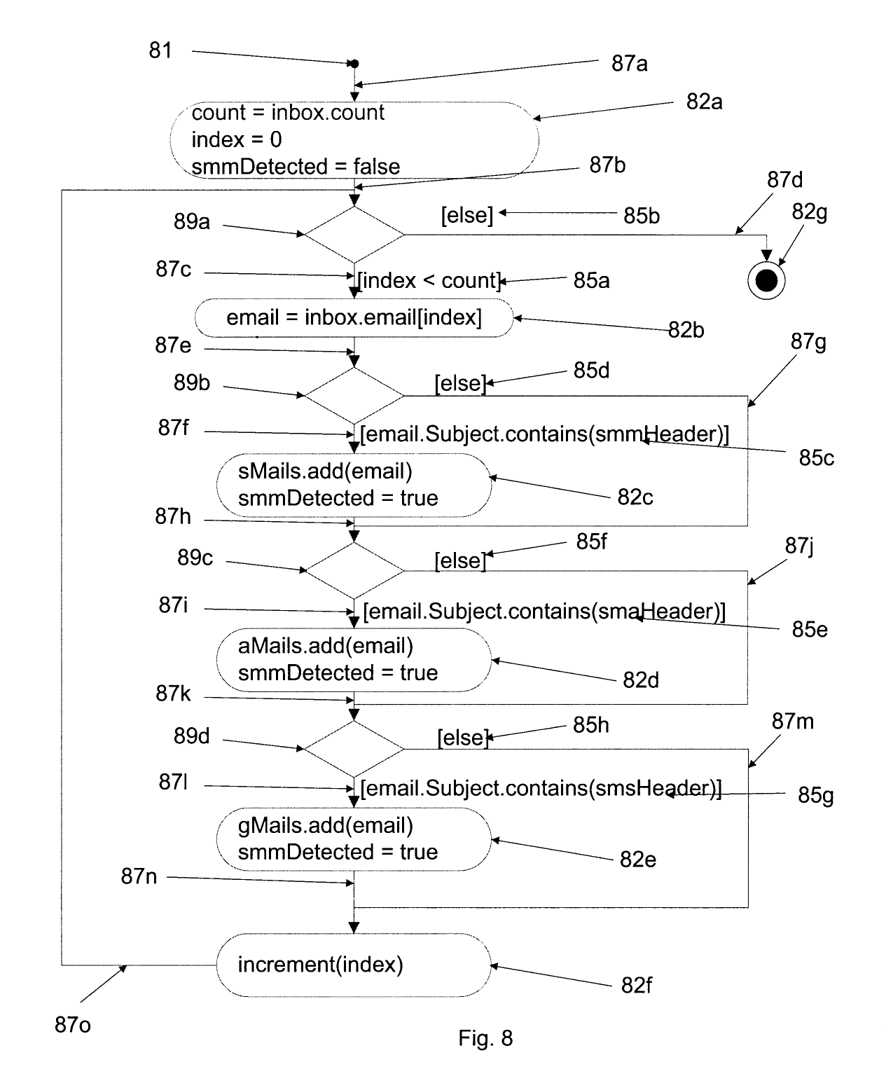

At the start of the component's state machine behavior, it enters and waits in the ‘waitingForNewMail’ state 72a until the email program 14 sends an event ‘evNewMailReceived’ 74a indicating new mail has been received in an inbox. The component responds to the event 74a by entering the ‘detectingSMMessage’ state 72b, wherein the entry action 73a2, ‘smmDetected=detectSMMessage( )’ 76c is performed. The ‘detectSMMessage( )’ state/operation is described below and shown in FIG. 8.

Upon return from the ‘detectSMMessagey operation, the decision 79a is evaluated. If ‘smmDetected’ 75b is true, a SplitMailMessage email, SplitMailAttachment email, or a SplitMailSegment email has been found, and the transition 77c-77d is taken, transitioning the state machine to ‘locatingNextSplitMail’ state 72c. Otherwise, ‘else’ 75c is true, and the transition 77c-77e is taken, returning the state machine to state 72a.

Upon entering the locatingNextSplitMail' state 72c, the entry action 73a3, ‘sMail=getNextSMMessage( )’ 76d is performed, wherein the next SplitMailMessage is retrieved, if any. Upon return from the operation, the decision 79b is evaluated. If sMail is not null 75d, a SplitMailMessage has been retrieved, and the transition 77f-77g is taken, transitioning the state machine to ‘locatingAllAttachments’ state 72d. Otherwise, ‘else’ 75e is true, and the transition 77f-77h is taken, returning the state machine to state 72a.

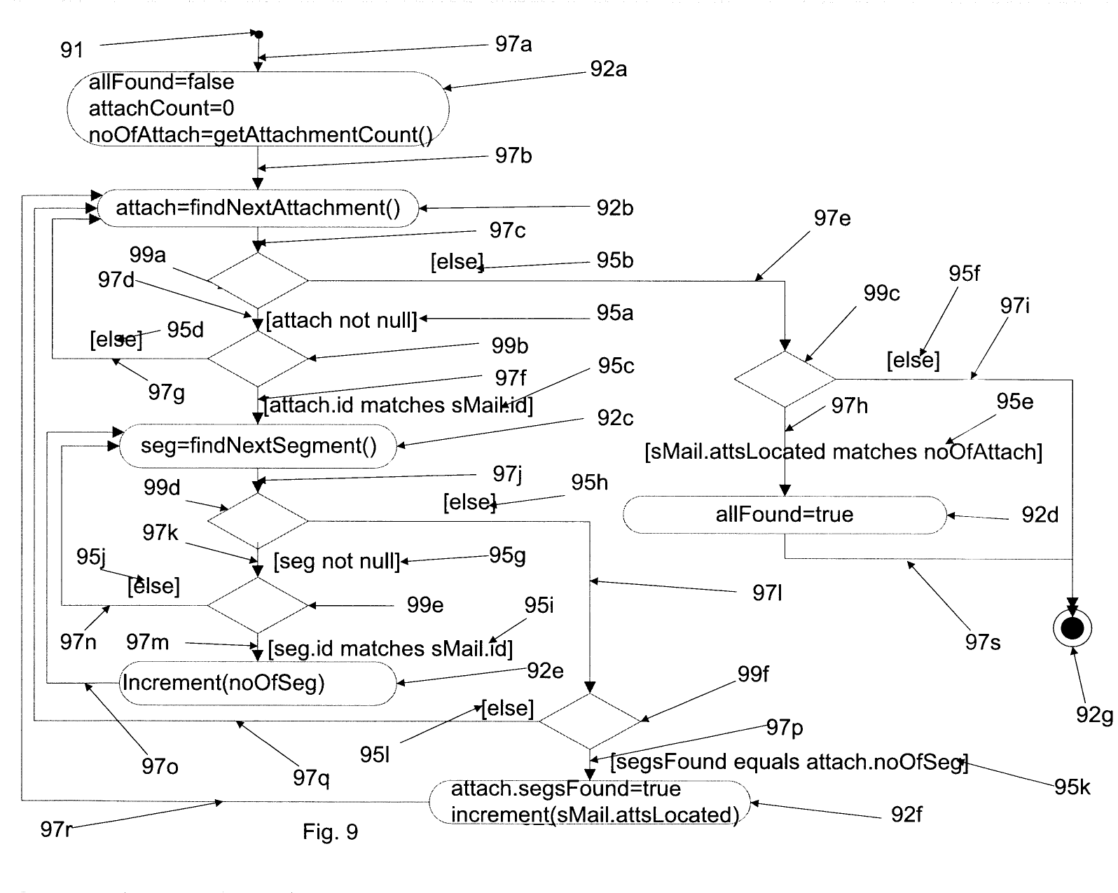

Upon entering the ‘locatingAllAttachments’ state 72d, the entry action 73a4, ‘allFound=locateAllAttachments( )’ 76e is performed. The ‘locateAllAttachments( )’ state/function is described below and shown in FIG. 9.

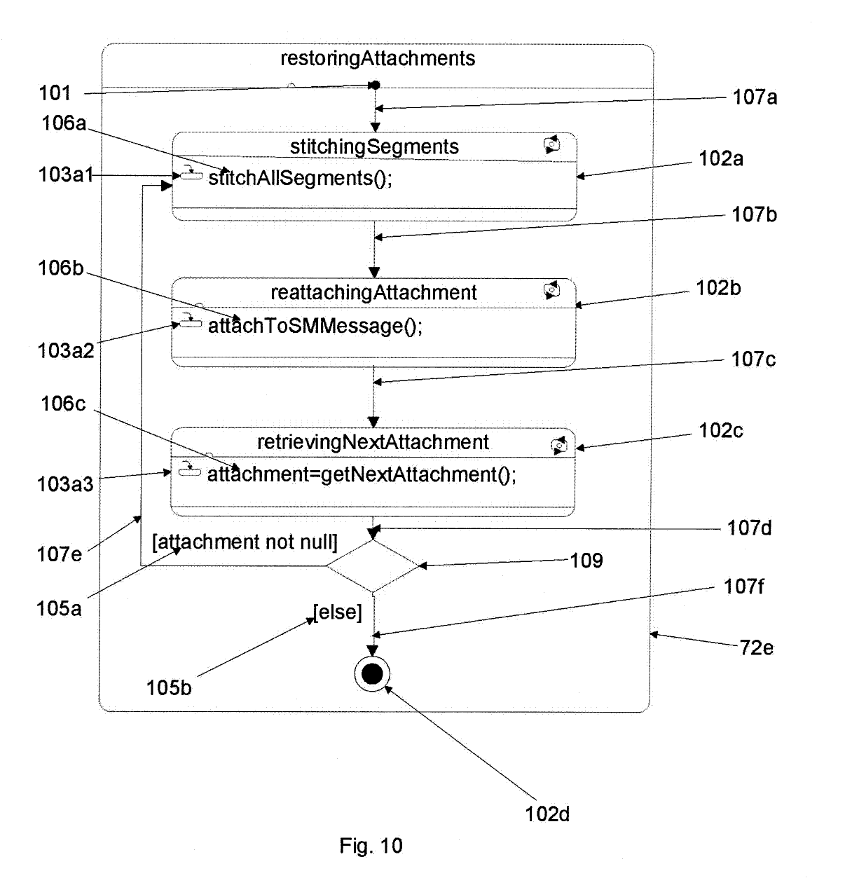

Upon return from the ‘locateAllAttachments( )’ operation, the decision 79c is evaluated. If ‘allFound’ 75e is true, then all attachment and segment emails for a SplitMaitMessage have been located, and the transition 77i-77j is taken, transitioning the state machine to ‘restoringAttachments’ state 72e and into the substate 78a. The ‘restoringAttachments’ 72e state is described below and shown in FIG. 10. Otherwise, ‘else’ 75f is true, and the transition 77i-77k is taken, returning the state machine to ‘locatingNextSMMessage’ state 72c, in order to handle any other SplitMaitMessages in the inbox.

Upon return from the sub-state 78a, the transition 77l is taken, transitioning the state machine to the ‘restoringSubject’ state 72f. Upon entering the ‘restoringSubject’ state 72f, the entry action 73a5 ‘restoreSubjectLine( )’ 76f is performed and the original subject is returned to the SplitMailMessage, restoring it to the original subject string entered by the user.

Upon return from the entry action 73a5, the transition 73m is taken, transitioning the state machine to the ‘deletingSMMessages’ state 72g, and into the sub-state machine 78b where the the individual SplitMailMessages are deleted. Upon return from the sub-state machine 78b, the transition 77n is taken, returning the state machine to the ‘locating nextSplitMail’ state 72c, for processing of another SplitMailMessage, if any more exist.

FIG. 8 shows the flowchart behavior of the ‘detectSMMessage’ operation 76c, which scans the presented for SplitMailMessage, SplitMailAttachment, SplitMailSegment emails, and gathers them for subsequent processing. Upon entry into the operation, the activity 82a is performed. There, the statement, ‘count=inbox.count’ is performed, setting count to the number of emails in the inbox. The statement, ‘index=0’ is performed, initializing the index. The statement, smmDetected=false is performed, initializing smmDetected to false. This value is returned to the caller when the operation completes.

Upon completion of the activity 82a, the transition 87b is taken, transitioning the operation to the decision 89a. If the guard, ‘index<count’ 85a, on alternative transition 87c is true, then transition 87c is taken, transitioning the operation into activity 82b. Otherwise, ‘else’ is true, and the transition 87d is taken, transitioning the operation to the ActivityFinal 82g, returning the value of smmDetected to the caller.

Upon entry into the activity 82b, the statement ‘email=inbox.email[index]’ is performed, and the transition 87e is taken to the decision 89b. If the guard, ‘email.subject contains(smmHeader)’ is true, then a SplitMailMessage email has been found, and the transition 87f is taken, transitioning the operation into activity 82c. Otherwise, ‘else’ is true, and the transition 87g is taken, transitioning the operation to the decision 89c.

Upon entry into the activity 82c, the statement, ‘sMail.add(email)’ is performed, adding the email to the SplitMailMessages list. Then the statement, ‘smmDetected=true’ is performed, indicating that at least one Split Mail Message has been found. Upon completion of the activity 82c, the transition 87h is taken, transitioning the operation to the decision 89c. If the guard, ‘email.subject contains(smaHeader)’ is true, then a SplitMailAttachment email has been found and the transition 87i is taken, transitioning the operation to the activity 82d. Otherwise, ‘else’ is true, and the transition 87j is taken, transitioning the operation to the decision 89d.

Upon entry into the activity 82d, the statement, ‘aMail.add(email)’ is performed, adding the SplitMailAttachment email to the SplitMailAttachments list. Then, the statement, ‘smmDetected=true’ is performed, indicating that at least one Split Mail Message has been found.

Upon completion of the activity 82d, the transition 87k is taken, transitioning the operation to the decision 89d. If the guard, ‘email.subject contains(smsHeader)’ is true, then a SplitMailSegment email has been found and the transition 87l is taken, transitioning the operation to the activity 82e. Otherwise, ‘else’ is true, and the transition 87m is taken, transitioning the operation into activity 82f.

Upon entry into the activity 82e, the statement, ‘gMail.add(email)’ is performed, adding the SplitMailSegment email to the SplitMailSegments list. The statement, ‘smmDetected=true’ is performed, indicating that at least one Split Mail Message has been found.

Once the activity 82e is completed, the transition 87n is taken, transitioning the operation to activity 82f. Then the statement ‘increment(index)’ is performed, incrementing the index by one in order to obtain the next email in the inbox. Once the activity 82f is completed, the transition 87o is taken, transitioning the operation back to the decision 89a, wherein the test as to whether any more emails are in the inbox is made.

FIG. 9 shows the flowchart behavior of the locateAllAttachments( )’ operation 76e, which retrieves all of the attachments for the current SplitMailMessage. If all SplitMailAttachment and all SplitMailSegment emails are found, then ‘allFound’ is returned as true.

Upon entry into the operation, the activity 93a is performed and the statement, ‘allFound=false’ is performed, setting initializing allFound to false. Then, the statement, ‘attachCount=0’ is performed, initializing the attachCount counter. Next, the statement, ‘noOfAttach=getAttachmentCount( )’ is performed, retrieving the number of attachments to be found from the coded information in the SplitMailAttchment email.

Upon completion of activity 92a, the transition 97b is taken, transitioning the operation to the activity 92b. There, the statement, ‘attach=findNextAttachment( )’ is performed, retrieving a SplitMailAttachment email.

Upon completion of activity 92b, the transition 97c is taken, transitioning the operation to decision 99a. If the guard ‘attach not null’ 95a is true, the transition 97d is taken, transitioning the operation to the decision 99b. Otherwise, ‘else’ 95b is true, and the transition 97e is taken, transitioning the operation to the decision 99c.

Upon reaching the decision 99b, if the guard ‘attach.id matches sMail.id’ 95c is true, then a SplitMailAttachment email belonging to the current SplitMailMessage has been found, and the transition 97f is taken, transitioning the operation to activity 92c. Otherwise, ‘else’ 95d is true, and the transition 97g is taken, transitioning the operation back to activity 92b to retrieve another SplitMailAttachment email for evaluation.

Upon reaching the decision 99c, if the guard ‘sMail.attsLocated matches noOfAttach’ 95e, this means that all of the SplitMailSegment emails for each of the SplitMailAttachment emails have been found, and the transition 97h is taken, transitioning the operation to activity 92d. Otherwise, ‘else’ 95f is true, and the transition 97i taken, transitioning the operation to the ActivityFinal 92g, returning allFound to the caller.

Upon reaching the activity 92c, the statement, ‘seg=findNextSegment( )’ is performed, retrieving the next SplitMailSegment email. Once the activity 92c has completed, the transition 97j is taken, transitioning the operation to the decision 99d. If the guard ‘seg not null’ 95g is true, then a SplitMailSegment email has been retrieved, and the transition 97k is taken, transitioning the operation to the decision 99e. Otherwise, ‘else’ 95h is true, and the transition 97l taken, transitioning the operation to the decision 99f.

Upon reaching the decision 99e, if the guard ‘seg.id matches sMail.id’ 95i is true, then the transition 97m is taken, transitioning the operation to the activity 92e. Otherwise, ‘else’ 95j is true, and the transition 97n taken, transitioning the operation back to activity 92c in order to retrieve another SplitMailSegment email for evaluation.

Upon reaching the decision 99f, if the guard ‘segsFound equals attach.noOfSeg’ 95k is true, then all SplitMailSegment emails for this SplitMailAttachment email have been found, and the transition 97p taken, transitioning the operation to the activity 92f.

Upon reaching the activity 92f, the statement ‘attach.segsFound=true’ is performed, indicating that all segments have been found for the attachment. Then the statement, ‘increment(sMail.attsLocated)’ is performed, indicating that a SplitMailAttachment email has been located with all of its SplitMailSegment emails also located.

Upon reaching the activity 92d, the statement, ‘allFound=true’ is performed, indicating that all of the SplitMailAttachment and SplitMailSegment emails have been located. Upon completion of the activity 92d, the transition 97s is taken, transitioning the operation to the ActivityFinal 92g, returning allFound to the caller.

FIG. 10 is a diagram of the sub-state machine behavior of ‘restoringAttachments’ state 72e, which locates and stitches all segments for an attachment back together, reattaches the stitched attachment back to the SplitMailMessage, and repeats this process for all split attachments.

Upon entry into the sub-state machine, the ‘stitchingSegments’ state 102a is entered, and the entry action 103a1 ‘stitchAllSegments( )’ 106a is performed, restoring the attachment to its original form. Upon return from the operation, the transition 107b is taken, transitioning the sub-state machine to ‘reattachingAttachment’ state 102b. Upon entry into the ‘reattachingAttachment’ state 102b, the entry action 103a2 ‘attachToSmMessage( )’ 106b is performed, to reattach the attachment to the SplitMailMessage with its original attachment filename. Upon return from the operation, the transition 107c is taken, transitioning the sub-state machine to ‘retrievingNextAttachment’ state 102c. Upon entry into the ‘retrievingNextAttachment’ state 102c, the entry action 103a3 ‘attachment=getNextAttachment( )’ 106c is performed, to retrieve the next attachment to process, if any.

Upon return from the operation, the decision 109 is evaluated. If ‘attachment not null’ 105a is true, then the transition 107d-107e is taken, transitioning the sub-state machine back to ‘stitchingSegments’ state 102a. Otherwise, ‘else’ 105b is true, and the transition 107d-107f taken, transitioning the sub-state machine to the termination state 102d, returning control to the state 72e.

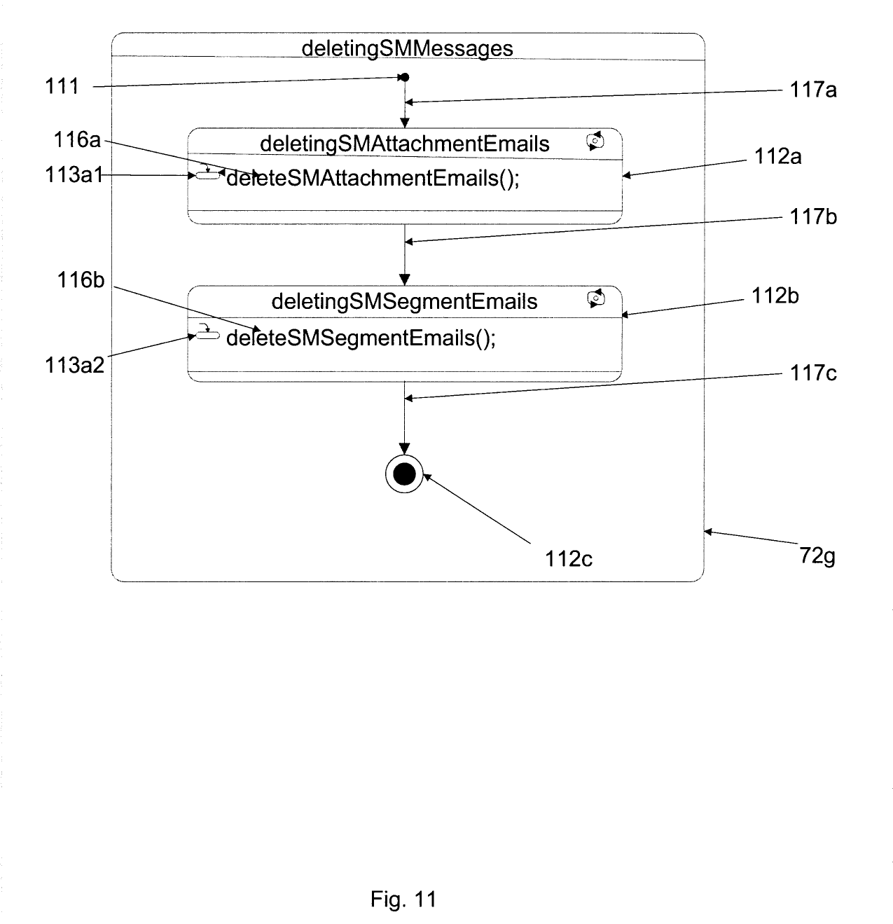

FIG. 11 is a diagram of the sub-state machine for ‘deletingSMMessages’ state 72g, which deletes all of the SplitMailAttachment and SplitMailSegment emails from the inbox. Upon entering the sub-state machine, the transition 117a is taken, transitioning the sub-state machine to ‘deletingSMAttachmentEmails’ state 112a. Upon entering the ‘deletingSMAttachmentEmails’ state 112a, the entry action 113a1 is taken, and the operation ‘deleteSMAttachmentEmails( )’ performed, which locates and deletes all of the SplitMailAttachment emails for the SplitMailMessage. Upon return from the operation, the transition 117b is taken, transitioning the sub-state machine to the ‘deletingSMSegmentEmails’ state 112b. Upon entering the ‘deletingSMSegmentEmails’ state 112b, the entry action 113a2 is taken, and the operation ‘deleteSMSegmentEmails’ performed, which locates and deletes all of the SplitMailSegment emails for the SplitMailMessage. Upon return from the operation, the transition 117c is taken, transitioning the sub-state machine to the termination state 112c, returning control to the state 72g.

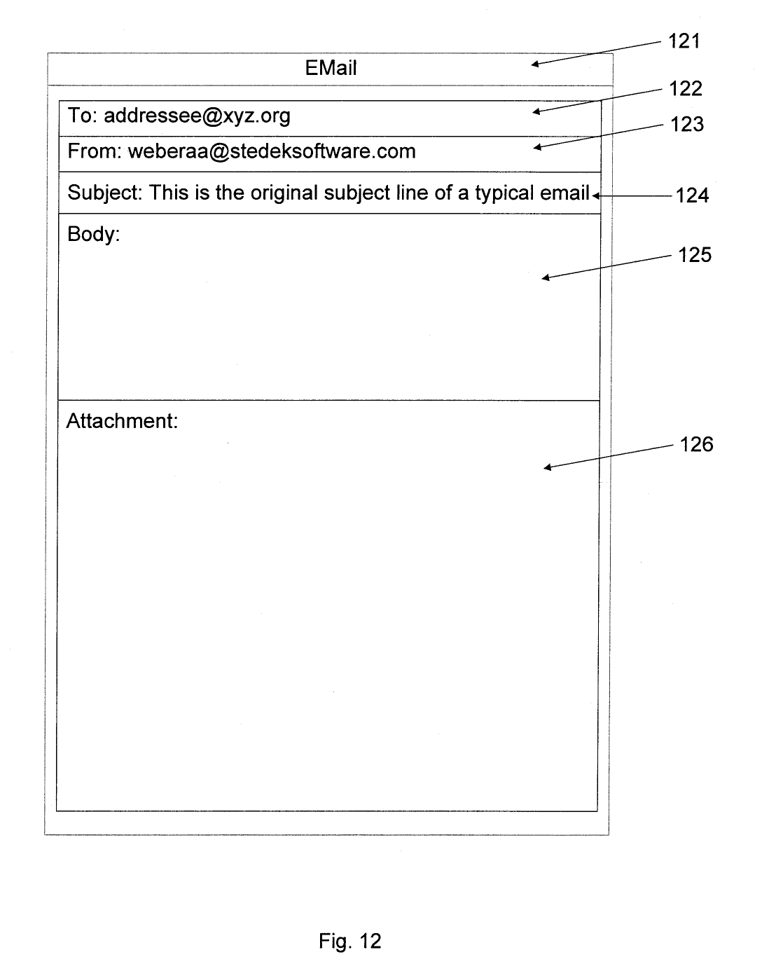

FIG. 12 is a diagram showing section or components of a typical email message 121. Each email consists of an addressee list 122 generally containing at least on recipient email address; the sender's email address 123, a subject field 124, a message body 125. The email may also contain one or more attachments 126.

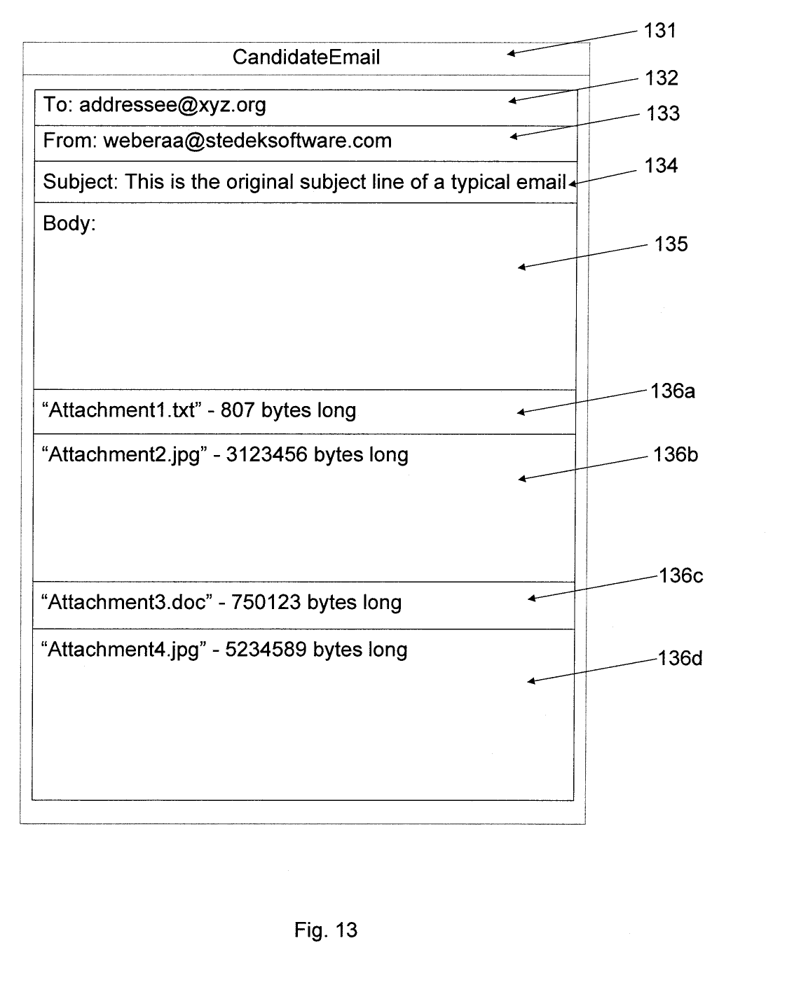

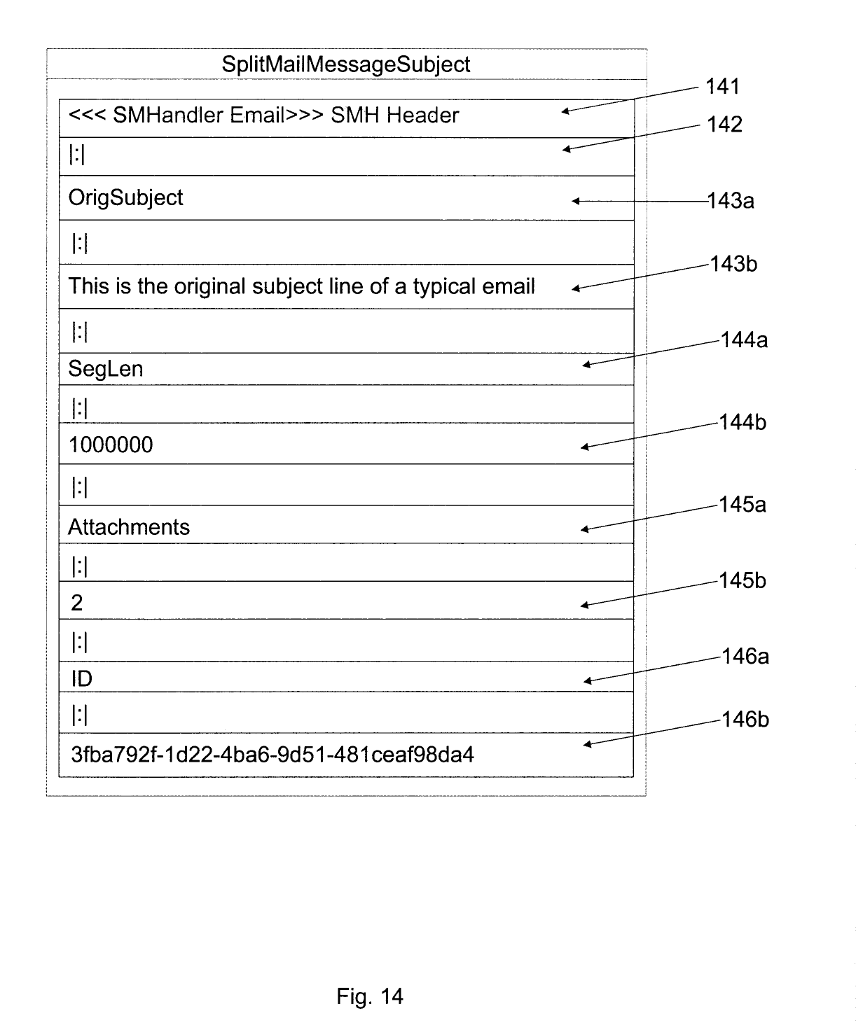

FIG. 13 is similar to FIG. 12 in that it shows sections or components of an email. This email, however, is an example of an email that would be considered a candidate for the system where the predefined threshold size was set to 1,000,000 byte because two of its attachments, 136b and 136d are both larger than the threshold. Once the sender sends this candidate email 131 within the email program 14, the program will inform the SentMailAttHandler thread 18 that a candidate email is being sent, and provide that email to the system for handling. The system will remove the two attachments, 136b and 136d, and change the candidate email's subject line to include coded original message information as explained below and shown in FIG. 14, making the email a SplitMailMessage email.

The system splits the attachment 136b is into four segments, three of them 1,000,000 bytes long, and the fourth 123,456 bytes long. An attachment email is created with the same addressees and author as the candidate email, and with a subject having coded attachment information as explained in below and shown in FIG. 15, making it a SplitMailAttachment email.

The system will create four segment emails and one segment attached to each of them. The system will use the same recipient address(es) and author information of the original message, and will a provide coded split information in the subject field as described below and shown in FIG. 16, making them SplitMailSegment emails. The attachment 136d is split into six segments, five of them 1,000,000 bytes long, and the sixth 234589 bytes long. The system will create an attachment email, as described for attachment 136b. The system will create six segment emails are created for attachment 136d, similar to that done for attachment 136b. In sum the system will create one SplitMailMessage, two SplitMailAttachments, and ten SplitMailSegment emails based on the candidate email 131.

FIG. 14 shows one embodiment of the coded original message information for the SplitMailMessage email. The subject consists of several text fields, each separated by a delimiter string 142, of “|:|”. The first field consists of a coded header 141, such as “<<<SMHandler Email>>>SMH Header”. The second field is an identifier string for the original subject 143a, of “OrigSubject”, followed by the third field, a text string 143b, containing the actual original subject. The fourth field is an identifier string 144a of “SegLen”, followed by the fifth field, a text string 144b, of “1000000”, which is the size of each of the segments in each attachment of the candidate email. The sixth field is an identifier string for the number of attachments 145a, of “Attachments”, followed by the seventh field, a text string 145b, containing the number of attachments, “2”, handled by the system. The eighth field is an identifier string for the split mail email set's identifier 146a, of “ID”, followed by the ninth field, an identifier 146b, such as a text string, which contains a globally unique identifier. For this example, the value of “3fba792f-1d22-4ba6-9d51-481ceaf98da4” has been used.

FIG. 15 shows one embodiment of the split the format of an encoded subject field according to an EncodeSubjectSplitMailAttachment function encoding coded attachment information for the SplitMailAttachment email. The Subject consists of several text fields, each separated by a delimiter string 152, of “|:|”. The first field consists of a specially coded header 151, “<<<SMHandler Email>>>SMH Attachment”. The second field is an identifier string for the number of the attachment in the example email 153a, of “AttNo”, followed by the third field, a text string 153b, containing the actual attachment number, “2”. The fourth field is an identifier string 154a for the filename of the attachment, “AttFileName”, followed by the fifth field, a text string 154b, of “Attachment2.jpg”, which is the filename of the attachment. The sixth field is an identifier string for the actual size in bytes of the attachment 155a, of “AttSize”, followed by the seventh field, a text string 155b, containing the actual size of the attachment, “3123456”. The eighth field is an identifier string for the number of segments that the attachment has been split into 156a, of “Segments”, followed by the ninth field, a text string 156b, containing the number of segments, “4”. The tenth field is an identifier string for the split mail email set's identifier 157a, of “ID”, followed by the eleventh field, a text string 157b, containing the same globally unique identifier of “3fba792f-1d22-4ba6-9d51-481ceaf98da4”, as found in the SplitMailMessage's subject.

FIG. 16 shows one embodiment of the format of an encoded subject field according to an EncodeSubjectSplitMailSegment function encoding coded split information for the SplitMailSegment email. The Subject consists of several text fields, each separated by a delimiter string 162, of “|:|”. The first field consists of a specially coded header 161, “<<<SMHandler Email>>>SMH Segment”. The second field is an identifier string for the number of the attachment in the example email 163a, of “AttNo”, followed by the third field, a text string 163b, containing the actual attachment number, “2”. The fourth field is an identifier string 164a for the number of the segment of the attachment, “SegNo”, followed by the fifth field, a text string 164b, of “1”, which is the number of this segment in the attachment. The sixth field is an identifier string for the size of this segment 165a, of “SegSize”, followed by the seventh field, a text string 165b, containing the size of the segment, “1000000”. The eighth field is an identifier string for the split mail email set's identifier 166a, of “ID”, followed by the eleventh field, an identifier 166b, such as a text string, containing the same globally unique identifier of “3fba792f-1d22-4ba6-9d51-481ceaf98da4”, as found in the SplitMailMessage's subject.

### Alternative Embodiment

In an alternative embodiment, the system may not create a separate split mail message, or attachment mail message(s), but instead may provide all the necessary coded information in the split segment emails themselves. In one embodiment, the necessary coded information is provided in the split segment emails by encoding all of the original email's body and any attachment information in the first of the segment emails, and by creating additional segment emails encoded similar to that encoding of the original embodiment; that is, by identifying each segment email by the original attachment of which it is a component and the segment position corresponding a defined portion of the original attachment. Globally unique identifiers would uniquely identify all segments in the email set, as in the original embodiment.

From the foregoing, it will be observed that numerous variations and modifications may be effected without departing from the spirit and scope of the invention. It is to be understood that no limitation with respect to the specific apparatus illustrated herein is intended or should be inferred. It is intended to cover by the appended claims all such modifications as fall within the scope of the claims.

1. The computer implemented method for handling email messages having one or more attachments, comprising the steps of:
intercepting an outgoing email having at least one recipient defining a destination address, a content area, and at least one attachment where the attachment size is greater than a predefined threshold size; the content area capable of containing a subject field and a message body field;
splitting the attachment into a plurality of attachment sub files where the size of each attachment sub file is equal or less than the threshold size;
creating a split segment email set having a split segment email corresponding to each of the attachment sub files;
attaching each attachment sub file to a corresponding split segment email;
encoding one or more of the split segment emails with coded split information to enable a split mail handler to combine the attachment sub files and to associate the recombined attachment with an email with having the original outgoing email content;
sending the split segment emails;
receiving the split segment email set at the destination address;
recreating the original email from the split segment email set.

2. The computer implemented method of claim 1, wherein the step of recreating comprises the steps of:
detecting a received email having split coded information;
determining the number of segments in the split segment email set from the split coded information;
finding each segment email in the split segment email set;
combining the attachment sub file of each segment email in the split segment email set to create a unified attachment corresponding to the original attachment; and
attaching the unified attachment to an email having the original outgoing email content thereby presenting the recipient with an email corresponding to the original outgoing email.

3. The computer implemented method of claim 2, wherein the step of finding comprises scanning a predefined location where emails are received to find each segment email in the split segment email set.

4. The computer implemented method of claim 1, wherein at least one split segment email is the outgoing email without the original attachment.

5. The computer implemented method of claim 1, wherein the step of encoding comprises the step of encoding each of the split segment email with coded split information.

6. The computer implemented method of claim 1, wherein
the step of intercepting comprises intercepting an outgoing message in an email client program on a sending computer;
the step of sending comprises causing the email client program to send the split segment emails; and
the step of receiving comprises receiving a split segment email set in an email client program on a receiving computer.

7. The computer implemented method of claim 1, after recreating, deleting all the segment emails.

8. The computer implemented method of claim 1, where the coded split information is contained in the subject field of the split segment email.

9. The computer implemented method of claim 1, comprising the steps of:
converting the original email message to a split message email by removing each attachment above the threshold size and adding coded original message information including an identifier, an attachment quantity value representing the a number of attachments of the original email, and the predefined threshold size;
creating a split attachment email for each attachment of the outgoing email, where the split attachment email contains with coded attachment information about the attachment including an identifier, a attachment name, a attachment size corresponding to the size of the original attachment, and the number of segments containing parts of the original attachment; and
wherein the step of sending comprises sending the split email message and each split attachment email;
and wherein the step of receiving comprises receiving the split email message and each split attachment email;
and wherein the step of recreating comprises recreating the original email with the unified attachment from the split message email, the split attachment email, and the split segment email set.

10. The computer implemented method of claim 9, wherein the step of recreating comprises the steps of:
reading the coded original message information in the split email message to determine the number of attachments contained in the original email;
finding the split attachment email corresponding to each original attachment based on the coded attachment information;
for each split attachment email,
reading the coded attachment information in said split attachment mail to determine the number of split segment emails in the split segment email set and the identifiers of those split segment emails,
finding each segment email in the split segment email set;
combining the attachment sub file of each segment email in the split segment email set to create a unified attachment corresponding to the original attachment; and
attaching the unified attachment to an email with having the original outgoing email content.

11. A computer program product for handling email messages having one or more attachments, the computer program product tangibly embodied and stored in an information carrier and comprising instructions that when executed by a processor perform a method, the method comprising:
intercepting an outgoing email created by a sending user and having at least one recipient defining a destination address, a content area, and at least one attachment where the attachment size is greater that a predefined threshold size; the content area capable of containing a subject field and a message body field;
splitting the attachment into a plurality of attachment sub files where the size of each attachment sub files is equal or less than the threshold size;
creating a split segment email set having a split segment email corresponding to each of the attachment sub files;
attaching each attachment sub file to a corresponding split segment email;
encoding one or more of the split segment emails with coded split information to enable a split mail handler to combine the attachment sub files and to associate the recombined attachment with an email with having the original outgoing email content;
sending the split segment emails.

12. The computer program product of claim 11, comprising the steps of:
receiving a sent split segment email set;
recreating the original email from the sent split segment email set.

13. The computer program product of claim 12, wherein in the step of recreating comprises the steps of:
detecting a received email having split coded information;
determining the number of segments in the split segment email set from the split coded information;
finding each segment email in the split segment email set;
combining the attachment sub file of each segment email in the split segment email set to create a unified attachment corresponding to the original attachment; and
attaching the unified attachment to an email having the original outgoing email content thereby presenting the recipient with an email corresponding to the original outgoing email.

14. The computer program product of claim 11, wherein at least one split segment email is the outgoing email without the original attachment.

15. The computer program product of claim 11, wherein the step of encoding comprises the step of encoding each of the split segment emails with coded split information.

16. The computer program product of claim 12, wherein the step of intercepting comprises intercepting an outgoing message in an email client program and wherein
the step of sending comprises causing the email client program to send the split segment emails and wherein
the step of receiving comprises receiving a split segment email set in an email client program.

17. The computer program product of claim 12, after recreating, deleting all the segment emails.

18. The computer program product of claim 12, comprising the steps of:
converting the original email message to a split message email by removing the attachment and adding coded original message information including an identifier, an attachment quantity value representing the a number of attachments of the original email, and the predefined threshold size;
creating a split attachment email for each attachment of the outgoing email, where the split attachment email contains coded attachment information about the attachment including an identifier, a attachment name, a attachment size corresponding to the size of the original attachment, and the number of segments containing parts of the original attachment;
wherein the step of sending comprises sending the split email message and each split attachment email;
and wherein the step of receiving comprises receiving the split email message and each split attachment email;
and wherein the step of recreating comprises recreating the original email from the split message email, the split attachment email, and the split segment email set.

19. The computer program product of claim 17, wherein the step of recreating comprises the steps of:
reading the coded original message information in the split email message to determine the number of attachments contained in the original email;
finding the split attachment email corresponding to each original attachment based on the coded attachment information; for each split attachment email;
reading the coded attachment information in said split attachment email to determine the number of split segment emails in the split segment email set and the identifiers of those split segment emails;
finding each segment email in the split segment email set;
combining the attachment sub file of each segment email in the split segment email set to create a unified attachment corresponding to the original attachment; and
attaching the unified attachment to an email with having the original outgoing email content.

20. (canceled)

21. A system comprising:
a means for intercepting an outgoing email created by a sending user and having at least one recipient defining a destination address, a content area, and at least one attachment where the attachment size is greater that a predefined threshold size; the content area capable of containing a subject field and a message body field;
a means for splitting the attachment into a plurality of attachment sub files where the size of each attachment sub files is equal or less than the threshold size;
a means for creating a split segment email set having a split segment email corresponding to each of the attachment sub files;
a means for attaching each attachment sub file to a corresponding split segment email;
a means for encoding one or more of the split segment emails with coded split information to enable a split mail handler to combine the attachment sub files and to associate the recombined attachment with an email with having the original outgoing email content;
a means for sending the split segment emails.
a means for receiving a sent split segment email set;
a means for detecting a received email having split coded information;
a means for determining the number of segments in the split segment email set from the split coded information;
a means for finding each segment email in the split segment email set;
a means for combining the attachment sub file of each segment email in the split segment email set to create a unified attachment corresponding to the original attachment; and
a means for attaching the unified attachment to an email with having the original outgoing email content thereby presenting the recipient with an email corresponding to the original outgoing email.
